(19) United States
(12) Patent Application Publication
(10) Pub. No.: US 2009/0000859 A1
(43) Pub. Date: Jan. 1, 2009

(54) Method and Apparatus for Phased Array Acoustic Well Logging

(75) Inventors: Tsili Wang, Katy, TX (US); Xiao Ming Tang, Sugar Land, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/770,377

(22) Filed: Jun. 28, 2007

(51) Int. Cl. G01V 1/44

(52) U.S. Cl. 181/106; 702/11

(57) ABSTRACT

A downhole acoustic logging tool uses a phased-array of transmitters and/or receivers to improve the signal level of compressional waves generated by the transmitters and propagating in the formation. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### BACKGROUND OF THE DISCLOSURE

1. Field of the Disclosure

The present disclosure pertains to logging while drilling apparatus and more particularly to acoustic logging while drilling apparatus and improving the signal-to-noise ratio of compressional wave pulses that travel parallel to the direction of drilling.

2. Summary of the Related Art

To obtain hydrocarbons such as oil and gas, wells or wellbores are drilled into the ground through hydrocarbon-bearing subsurface formations. Currently, much current drilling activity involves not only vertical wells but also drilling horizontal wells. In drilling, information from the well itself must be obtained. While seismic data has provided information as to the area to drill and approximate depth of a pay zone, the seismic information can be not totally reliable at great depths. To support the data, information is obtained while drilling through logging while drilling or measuring while drilling (MWD) devices. Logging-while-drilling, or measuring-while-drilling are procedures that have been in use for many years. This procedure is preferred by drillers because it can be accomplished without having to stop drilling to log a hole. This is primarily due to the fact that logging an unfinished hole, prior to setting casing if necessary, can lead to washouts, damaging the drilling work that has already been done. This can stall the completion of the well and delay production. Further, this information can be useful while the well is being drilled to make direction changes immediately. Measurements, however, are taken long after the actual drilling of the well.

An important part of determining the properties of subsurface formations involves measurement of compressional and shear wave velocities. This is typically done by exciting acoustic waves using a transmitter and receiving compressional (P-waves) and shear waves (S-waves) through formation and analyzing signals received by an array of receivers. It is also common practice to measure acoustic waves propagating through the borehole.

P-waves usually have much lower amplitude than S-waves. The large difference in signal amplitude makes the detection and measurement of P-waves more difficult. The problem is worse for logging while drilling (LWD) because of the interference of waves propagating along the tool. For wireline tools, acoustic isolators can be designed that almost completely block the tool wave so that there is little contamination of the formation arrival by the tool signal. See, for example, U.S. Pat. No. 5,229,553 to Lester. However, for an MWD tool, the mechanical strength constraints limit the performance of the acoustic isolator. Examples of acoustic isolators for LWD are shown, for example, U.S. Pat. No. 6,082,484 to Molz et al., in U.S. Pat. No. 6,615,949 to Egerev et al., U.S. Pat. No. 6,820,716 to Redding et al., U.S. Pat. No. 6,915,875 to Dubinsky et al., U.S. Pat. No. 7,028,806 to Dubinsky et al., and U.S. Pat. No. 7,032,707 to Egerev et al all having the same assignee as the present disclosure. See also U.S. Pat. No. 7,216,737 to Sugiyama, U.S. Pat. No. 5,639,997 to Mallett.

### SUMMARY OF THE DISCLOSURE

One embodiment of the disclosure is an apparatus for logging an earth formation. The apparatus includes a logging tool having at least one transmitter which includes a plurality of segments. The logging tool is configured to be conveyed in a borehole and generate an acoustic wave in the formation. At least one receiver is configured to produce a signal responsive to the generated acoustic wave. The apparatus further includes a processor configured to activate the plurality of segments using a time delay which accentuates an axially propagating compressional wave in the formation, determine from the signal a compressional wave velocity of the formation, and record the determined compressional wave velocity on a suitable medium. The at least one receiver may include a plurality of spaced-apart receivers forming a receiver array. The processor may further be configured to determine the time delay based at least in part on an estimated compressional wave velocity and a spacing between the segments of the at least one transmitter. The processor may further be configured to improve the determined compressional wave velocity using redundancy in signals received by the plurality of receivers. The processor may be further configured to estimate a shear wave velocity of the formation. The logging tool may be part of a downhole assembly conveyed on a drilling tubular or a wireline.

Another embodiment of the disclosure is a method of logging an earth formation. The method includes conveying at least one transmitter having a plurality of segments into a borehole, sequentially activating the plurality of segments using a time delay which accentuates a compressional wave component of a generated acoustic wave in the formation, using at least one receiver to produce a signal responsive to be generated acoustic wave, determining from the signal a compressional wave velocity of the formation, and recording the determined compressional wave velocity on a suitable medium. The method may include using for the at least one receiver a plurality of spaced apart receivers forming a receiver array. The time delay may be determined based at least in part on an estimated compressional wave velocity and a spacing between the segments of the at least one transmitter. The method may further include improving the determined compressional wave velocity using information redundancy in signals received by the plurality of receivers. The method may further include estimating a shear wave velocity of the formation.

Another embodiment of the disclosure is an apparatus for logging an earth formation. The apparatus includes a logging tool configured to be conveyed in a borehole. At least one transmitter on the logging tool is configured to generate an acoustic wave in the formation. The apparatus further includes at least one receiver including a plurality of segments, each of the segments configured to produce a signal in response to the generated acoustic wave. The apparatus also includes a processor configured to combine the signals from the plurality of segments using a time delay which accentuates an axially propagating compressional wave in the formation, determine from the combined signal a compressional wave velocity of the formation, and record the determined compressional wave velocity on a suitable medium. The at least one receiver may further comprise a plurality of spaced apart receivers forming a receiver array. The processor may be further configured to determine the time delay based at least in part on an estimated compressional wave velocity and a spacing between the segments of the at least one receiver. The processor may be further configured to improve the determined compressional wave velocity using information redundancy in signals by the plurality of receivers. The processor may be further configured to estimate a shear wave velocity of the formation. The logging tool may be part of a downhole assembly conveyed on a drilling tubular or a wireline.

Another embodiment of the disclosure is a method of logging an earth formation. The method includes conveying at least one transmitter into a borehole and generating an acoustic wave. Each of a plurality of segments of at least one receiver is used to produce a signal responsive to the generated acoustic wave. The signals from the plurality of segments are combined using a time delay which accentuates an axially propagating compressional wave in the formation. A compressional wave velocity of the formation is determined from the combined signal and recorded on a suitable medium. A plurality of receivers forming a receiver array may be used for the at least one receiver. The time delay may be determined based at least in part on an estimated compressional wave velocity and a spacing between the segments of the at least one receiver. The determined compressional wave velocity may be improved by using information redundancy in signals generated by the plurality of receivers. The method may further include estimating a shear wave velocity of the formation.

### BRIEF DESCRIPTION OF THE FIGURES

For detailed understanding of the present disclosure, references should be made to the following detailed description of exemplary embodiment(s), taken in conjunction with the accompanying drawings, in which like elements have been given like numerals, wherein:

FIG. 1 is an illustration of a bottomhole assembly (BHA) deployed in a borehole from a drilling tubular that includes the apparatus according to one embodiment of the present disclosure;

FIG. 2 is an illustration of a phased-transmitter array used for generating signals recorded by a receiver array;

FIG. 3 is an illustration showing P-wave signals recorded by the apparatus of FIG. 2 without and with the use of the phased array;

FIG. 4 illustrates the complete wave train including the S-wave arrival; and

FIG. 5 is an illustration of a phased-receiver array used for recording signals from a transmitter.

### DETAILED DESCRIPTION OF THE EMBODIMENTS

In view of the above, the present disclosure through one or more of its various aspects and/or embodiments is presented to provide one or more advantages, such as those noted below.

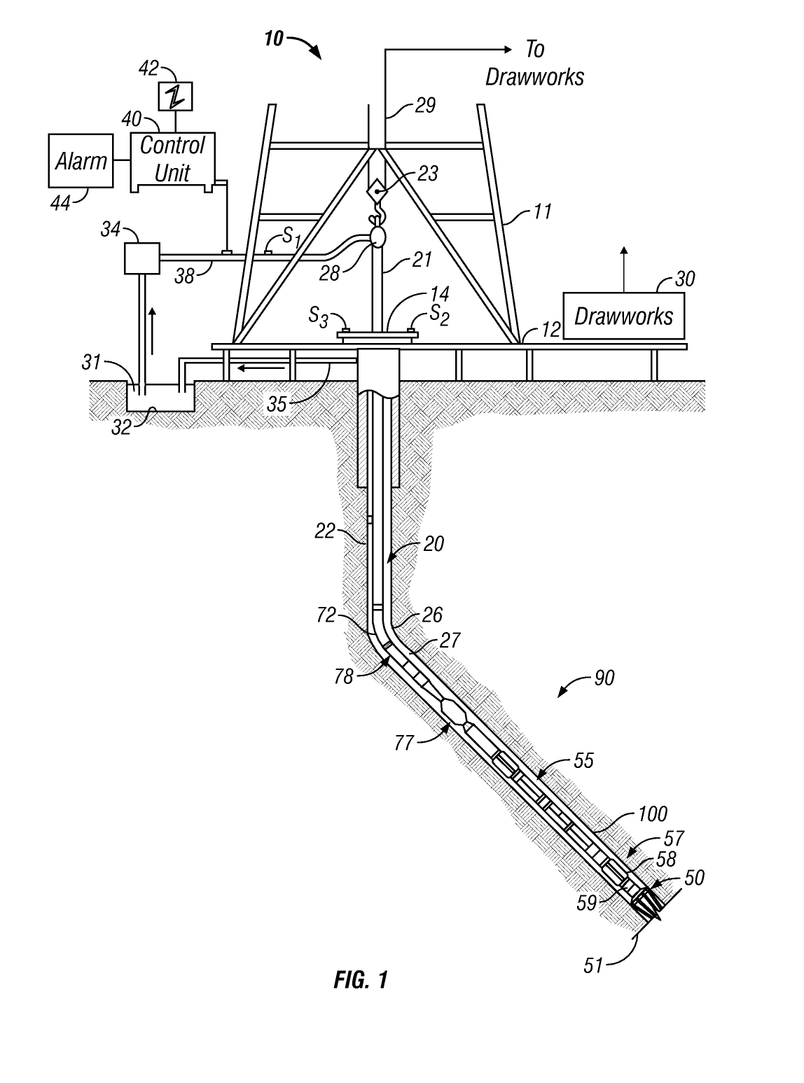

FIG. 1 illustrates a schematic diagram of an MWD drilling system 10 with a drill string 20 carrying a drilling assembly 90 (also referred to as the bottom hole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drill string 20 includes tubing such as a drill pipe 22 or a coiled-tubing extending downward from the surface into the borehole 26. The drill string 20 is pushed into the wellbore 26 when a drill pipe 22 is used as the tubing. For coiled-tubing applications, a tubing injector (not shown), however, is used to move the tubing from a source thereof, such as a reel (not shown), into the wellbore 26. The drill bit 50 attached to the end of the drill string 20 breaks up the geological formations when it is rotated to drill the borehole 26. If a drill pipe 22 is used, the drill string 20 is coupled to a drawworks 30 via a Kelly joint 21, swivel 28 and line 29 through a pulley 23. During drilling operations, the drawworks 30 is operated to control the weight on bit, a parameter that affects the rate of penetration. The operation of the drawworks is well known in the art and is thus not described in detail herein.

During drilling operations, a suitable drilling fluid 31 from a mud pit (source) 32 is circulated under pressure through a channel in the drill string 20 by a mud pump 34. The drilling fluid passes from the mud pump 34 into the drill string 20 via a desurger 36, fluid line 38 and Kelly joint 21. The drilling fluid 31 is discharged at the borehole bottom 51 through openings in the drill bit 50. The drilling fluid 31 circulates uphole through the annular space 27 between the drill string 20 and the borehole 26 and returns to the mud pit 32 via a return line 35. The drilling fluid acts to lubricate the drill bit 50 and to carry borehole cutting or chips away from the drill bit 50. A sensor S₁ preferably placed in the line 38 provides information about the fluid flow rate. A surface torque sensor S₂ and a sensor S₃ associated with the drill string 20 respectively provide information about the torque and rotational speed of the drill string. Additionally, a sensor (not shown) associated with line 29 is used to provide the hook load of the drill string 20.

Rotating the drill pipe 22 rotates the drill bit 50. Also, a downhole motor 55 (mud motor) may be disposed in the drilling assembly 90 to rotate the drill bit 50 and the drill pipe 22 is rotated usually to supplement the rotational power, if required, and to effect changes in the drilling direction.

In the embodiment of FIG. 1, the mud motor 55 is coupled to the drill bit 50 via a drive shaft (not shown) disposed in a bearing assembly 57. The mud motor 55 rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

A drilling sensor module 59 is placed near the drill bit 50. The drilling sensor module 59 contains sensors, circuitry and processing software and algorithms relating to the dynamic drilling parameters. Such parameters may include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module 59 processes the sensor information and transmits it to the surface control unit 40 via the telemetry system 72.

The communication sub 72, a power unit 78 and an NMR tool 79 are all connected in tandem with the drill string 20. Flex subs, for example, are used in connecting the MWD tool 79 in the drilling assembly 90. Such subs and tools form the bottom hole drilling assembly 90 between the drill string 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals may be processed using a downhole processor in the drilling assembly 90.

The surface control unit or processor 40 also receives signals from other downhole sensors and devices, signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 preferably includes a computer or a microprocessor-based processing system, memory for storing programs or models and data, a recorder for recording data, and other peripherals. The control unit 40 is preferably adapted to activate alarms 44 when certain unsafe or undesirable operating conditions occur. An acoustic logging tool 100 (discussed next) may be positioned at a suitable location such as shown.

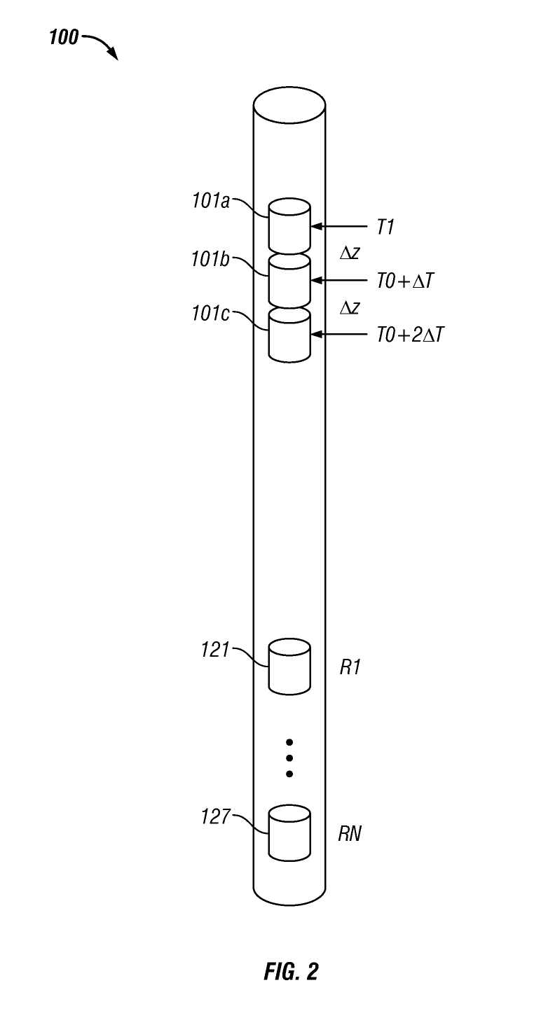

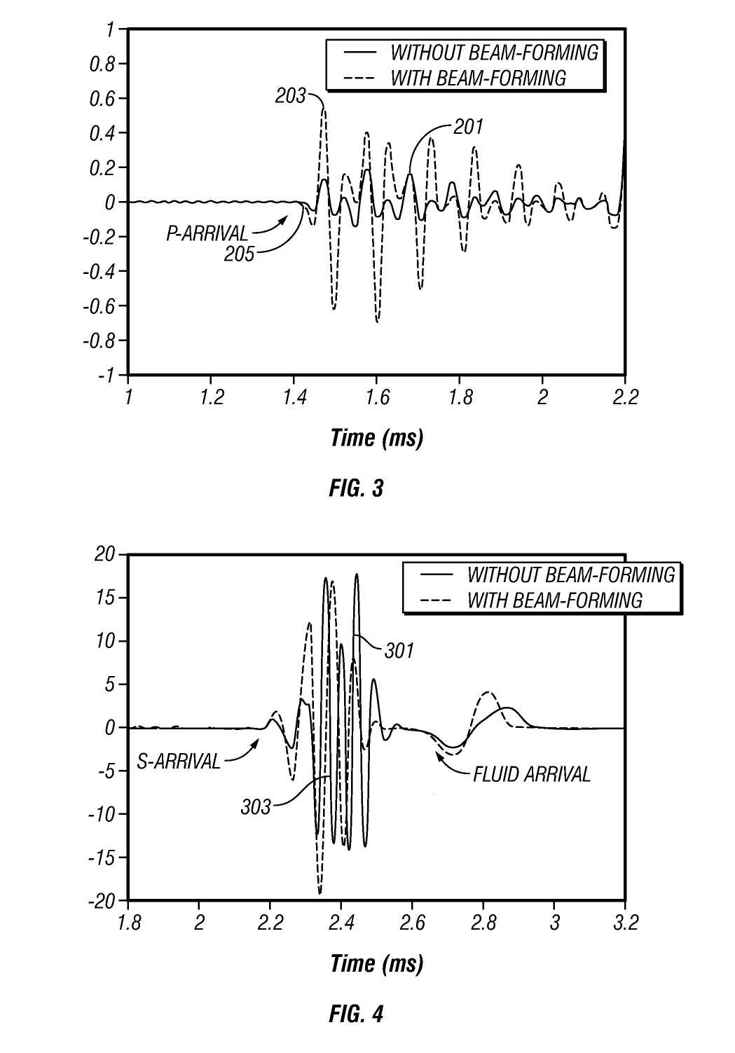

Turning now to FIG. 2, an exemplary tool 100 using the method of the present disclosure is illustrated. As would be known to those versed in the art, a downhole acoustic source (or receiver) usually has a finite length. The source may consist of several segments stacked in the tool axial direction. This may be referred to as a transmitter assembly. In one embodiment of the disclosure, the elements are piezoelectric transducers. In prior art devices, the segments 101a, 101b, 101c are fired at the same time. The waves induced by neighboring segments travel to a receiver such as 121 at slightly delayed times. In other words, the waves tend to be out of phase. When stacked over time, the waves will interfere destructively with each other to a certain degree and will have more ringing than that of a single segment. This is illustrated in FIG. 3 by the waveform 201 that is the result of simultaneous excitation of three point sources at distances of 11 ft, 11.2 ft and 11.4 ft (3.35 m, 3.41 m and 3.47 m) from a receiver. The abscissa is time in milliseconds and the ordinate is the signal amplitude in arbitrary units. The display in FIG. 3 has been selected so that the shear wave arrival cannot be seen. It should be noted that receiver 121 is part of an array that includes additional receivers such as 127. The array of receivers may be referred to as a receiver assembly. In one embodiment, six receivers are used, though more than six or less than six may be used.

The present disclosure uses a phased array approach. The different segments of the transmitter are fired in such a time sequence that the farthest segment is fired first, the second one fired with a predefined time delay, and so on. Referring back to FIG. 2, the segments are fired with a time delay ΔT. By selecting an appropriate time delay (0.04 ms in this example), all the compressional waves arrive at the receiver at the same or approximately the same time. Stacking of the waves will produce a stronger signal. In the example shown, ΔT=Δz/V_{f}, where Δz is the spacing between the segments and V_{f} is the formation P-wave velocity. This result of using this phased-array approach is shown in FIG. 3 by 203. As can be seen, the signal strength is much greater than in 201 where the different segments are fired simultaneously. The P-wave arrival 205 can easily be picked. It should be noted that an approximate value of the formation velocity is sufficient to provide this improvement.

Turning now to FIG. 4, the entire wave train for the example of FIG. 3 is illustrated. Note that the scale is compressed relative to that of FIG. 3. It can be seen that even though the time delays were chosen to emphasize the P-wave arrival, the S-wave arrival 301 can still be seen as can the fluid arrival 303.

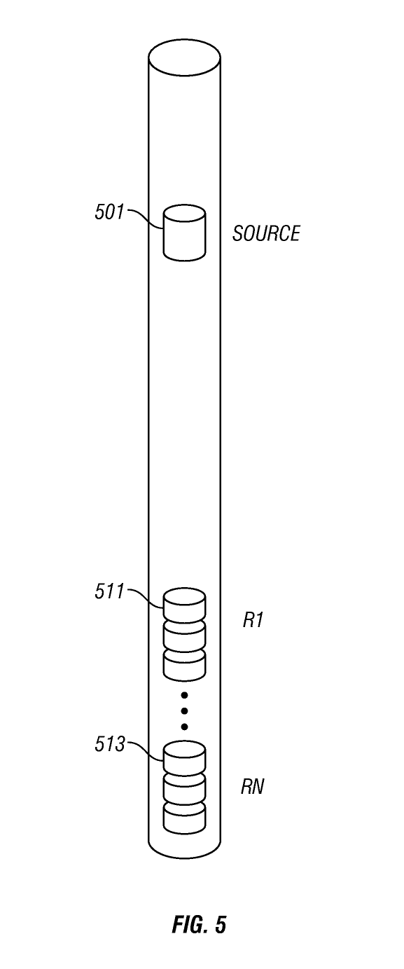

An alternate embodiment of the disclosure is illustrated in FIG. 5. Shown therein is a transmitter 501 and an array of receivers (of which two—511, 513) are shown. Each of the receivers comprises a plurality of segments, the signals from the segments being delayed relative to each other prior to summing by using suitable electronic circuitry or a processor (not shown). With either configuration (FIG. 2 or FIG. 5), the recorded signals are processed to determine formation P-wave velocities and, optionally, S-wave velocities. See, for example, U.S. Pat. No. 6,477,112 to Tang, the contents of which are incorporated herein by reference. As discussed therein, improved results are achieved by minimizing the noise contamination effects by maximizing the information redundancy in waveform data with multiple receivers.

The determined velocity can be used in conjunction with the downhole or surface data for imaging of reflectors, determination or formation lithology, and determination off the fluid content of formations using known methods.

The description above has been in terms of a device conveyed on a BHA on a drilling tubular into a borehole in the earth formation. The method and apparatus described above could also be used in conjunction with a logging string conveyed on a wireline into the earth formation. For the purposes of the present disclosure, the BHA and the logging string may be referred to as a “downhole assembly.” It should further be noted that while the example shown depicted the transmitter assembly and the receiver assembly on a single tubular, this is not to be construed as a limitation of the disclosure. It is also possible to have a segmented acoustic logging tool to facilitate conveyance in the borehole.

The time delays may be implemented by a suitable firing circuit under microprocessor control. Implicit in the processing of the data is the use of a computer program implemented on a suitable machine readable medium that enables the processor to perform the control and processing. The machine readable medium may include ROMs, EPROMs, EAROMs, Flash Memories and Optical disks. The determined formation velocities may be recorded on a suitable medium and used for subsequent processing upon retrieval of the BHA. The determined formation velocities may further be telemetered uphole for display and analysis.

The foregoing description is directed to particular embodiments of the present disclosure for the purpose of illustration and explanation. It will be apparent, however, to one skilled in the art that many modifications and changes to the embodiment set forth above are possible without departing from the scope and the spirit of the disclosure. It is intended that the following claims be interpreted to embrace all such modifications and changes.

What is claimed is:

1. An apparatus for logging an earth formation; the apparatus comprising:
(a) a logging tool including at least one transmitter comprising a plurality of segments configured to be conveyed in a borehole and generate an acoustic wave in the formation;
(b) at least one receiver configured to produce a signal responsive to the generated acoustic wave; and
(c) a processor configured to:
(A) activate the plurality of segments sequentially using a time delay which accentuates an axially propagating compressional wave in the formation,
(B) determine from the signal a compressional wave velocity of the formation; and
(C) record the determined compressional wave velocity on a suitable medium.

2. The apparatus of claim 1 wherein the at least one receiver further comprises a plurality of spaced apart receivers forming a receiver array.

3. The apparatus of claim 1 wherein the processor is further configured to determine the time delay based at least in part on an estimated compressional wave velocity and a spacing between the elements of the at least one transmitter.

4. The apparatus of claim 2 wherein the processor is further configured to improve the estimated compressional wave velocity using redundancy in signals received by the plurality of receivers.

5. The apparatus of claim 1 wherein the processor is further configured to estimate a shear wave velocity of the formation.

6. The apparatus of claim 1 wherein the logging tool is part of a downhole assembly conveyed on one of: (i) a drilling tubular, and (ii) a wireline.

7. A method of logging an earth formation; the method comprising:
(a) conveying at least one transmitter comprising a plurality of segments into a borehole;
(b) sequentially activating the plurality of segments using a time delay which accentuates a compressional wave component of a generated acoustic wave in the formation,
(c) using at least one receiver to produce a signal responsive to the generated acoustic wave;
(d) determining from the signal a compressional wave velocity of the formation; and
(e) recording the determined compressional wave velocity on a suitable medium.

8. The method of claim 7 further comprising using for the at least one receiver a plurality of spaced apart receivers forming a receiver array.

9. The method of claim 7 further comprising determining the time delay based at least in part on an estimated compressional wave velocity and a spacing between the elements of the at least one transmitter.

10. The method of claim 8 further comprising improving the determined compressional wave velocity using information redundancy in signals received by the plurality of receivers.

11. The method of claim 7 further comprising estimating a shear wave velocity of the formation.

12. An apparatus for logging an earth formation; the apparatus comprising:
(a) at least one transmitter on a logging tool configured to be conveyed in a borehole and generate an acoustic wave in the formation;
(b) at least one receiver comprising a plurality of segments, each of the plurality of segments configured to produce a signal responsive to the generated acoustic wave; and
(c) a processor configured to:
(A) combine the signals from the plurality of segments using a time delay which accentuates an axially propagating compressional wave in the formation,
(B) determine from the combined signal a compressional wave velocity of the formation; and
(C) record the determined compressional wave velocity on a suitable medium.

13. The apparatus of claim 12 wherein the at least one receiver further comprises a plurality of spaced apart receivers forming a receiver array.

14. The apparatus of claim 12 wherein the processor is further configured to determine the time delay based at least in part on an estimated compressional wave velocity and a spacing between the segments of the at least one receiver.

15. The apparatus of claim 13 wherein the processor is further configured to improve the determined compressional wave velocity using information redundancy in signals received by the plurality of receivers.

16. The apparatus of claim 12 wherein the processor is further configured to estimate a shear wave velocity of the formation.

17. The apparatus of claim 12 wherein the logging tool is part of a downhole assembly conveyed on one of: (i) a drilling tubular, and (ii) a wireline.

18. A method of logging an earth formation; the method comprising:
(a) conveying at least one transmitter into a borehole and generating an acoustic wave;
(b) using at least one receiver comprising a plurality of segments, each segment producing a signal responsive to the generated acoustic wave; and
(c) combining the plurality of signals using a time delay which accentuates an axially propagating compressional wave in the formation,
(d) determining from the combined signal a compressional wave velocity of the formation; and
(e) recording the determined compressional wave velocity on a suitable medium.

19. The method of claim 18 further comprising using for the at least one receiver a plurality of spaced apart receivers forming a receiver array.

20. The method of claim 18 further comprising determining the time delay based at least in part on an estimated compressional wave velocity and a spacing between the elements of the at least one receiver.

21. The method of claim 19 further comprising improving the determined compressional wave velocity using information redundancy in signals received by the plurality of receivers.

22. The method of claim 18 further comprising estimating a shear wave velocity of the formation.
